(19) United States
(12) Patent Application Publication
(10) Pub. No.: US 2012/0250643 A1
(43) Pub. Date: Oct. 4, 2012

(54) METHOD FOR INDICATING DOWNLINK PHYSICAL RESOURCES SCHEDULING IN A WIRELESS COMMUNICATION SYSTEM

(75) Inventors: Hong HE, Chaoyang District (CN); Chengjun SUN, Chaoyang District (CN)

(73) Assignee: SAMSUNG ELECTRONICS CO. LTD., Suwon-si (KR)

(21) Appl. No.: 13/437,281

(22) Filed: Apr. 2, 2012

(30) Foreign Application Priority Data
Apr. 2, 2011 (CN) 201110086061.0

(51) Int. Cl. H04W 72/04

(52) U.S. Cl. 370/329

(57) ABSTRACT

A method and apparatus for indicating downlink physical resources scheduling in a wireless communication system are provided. The method includes sending downlink control information to a User Equipment (UE) on a first component carrier by an evolved Node B (eNB), wherein single downlink control information is used to schedule physical resources in at least one downlink sub-frame of one of a plurality of component carriers at a time, the plurality of component carriers including the first component carrier, a second component carrier, . . . , a kth component carrier, wherein k is greater than or equal to 2, receiving the downlink control information on the first component carrier, and receiving downlink data according to the downlink control information by the UE. The present invention can achieve a peak data rate to reach the design target of International Mobile Telecommunications (IMT)-Advanced system.

### PRIORITY

This application claims the benefit under 35 U.S.C. §119(a) of a Chinese patent application filed in the State Intellectual Property Office of the People's Republic of China on Apr. 2, 2011 and assigned Serial No. 201110086061.0, the entire disclosure of which is hereby incorporated by reference.

### BACKGROUND OF THE INVENTION

1. Field of the Invention

The present invention relates to mobile communication techniques. More particularly, the present invention relates to a method for indicating downlink physical resource scheduling in a wireless communication system.

2. Description of the Related Art

In the current Long Term Evolution (LTE) standard of the 3rd Generation Partnership Project (3GPP), the downlink transmission technique uses Orthogonal Frequency Division Multiplexing (OFDM) as its basis and the uplink transmission technique is based on Single-Carrier Frequency Division Multiple Access (SC-FDMA).

An LTE system comprises two types of frame structures. Frame structure type 1 uses Frequency Division Duplex (FDD), and frame structure type 2 uses Time Division Duplex (TDD).

FIG. 1 is a schematic diagram illustrating a frame structure configuration of a Time Division (TD)-LTE system according to the prior art.

Referring to FIG. 1, frame structure 2 includes seven different frame structure configurations, and the ratio of downlink sub-frames in the different kinds of frame structure configurations vary, ranging from 40% to 90%. It can be clearly seen from FIG. 1 that each radio frame comprises 10 wireless sub-frames which are sequentially numbered from 0.

Taking Configuration 0 as an example, sub-frame 0 and sub-frame 5 are used to carry downlink data. That is, the sub-frame 0 and sub-frame 5 carry information sent from an evolved Node B (eNB) to a User Equipment (UE);

Sub-frames 2, 3 and 4 as well as sub-frames 7, 8 and 9 are used to carry uplink data. That is, sub-frames 2, 3, 4, 7, 8 and 9 are used to carry information from the UE to the eNB.

Sub-frames 1 and 6 are called Special Sub-frames because they comprise 3 special timeslots which are defined as a Downlink Pilot Time Slot (DwPTS), a Guard Period (GP) and an Uplink Pilot Time Slot (UpPTS). The duration of the DwPTS timeslot, the GP timeslot, and the UpPTS timeslot is variable, and specific duration values are configured by the system. The Special Sub-frames are used to carry downlink data, and they could be regarded as a shortened downlink sub-frames.

Evolution of the LTE system is referred to as “LTE-Advanced”, which is shortened as LTE-A and aims at satisfying the requirement of the International Mobile Telecommunications (IMT)-Advanced system as established by the International Telecommunication Union (ITU). The goals of IMT-Advanced include further upgraded data rate, interoperability/compatibility with other system(s), a worldwide roaming feature, and so on. The target data rate is to reach 1 Gbps on the downlink and 500 Mbps on the uplink.

Based on the above goals, Carrier Aggregation (CA) is introduced in version 10 of LTE. In CA, a system bandwidth of up to 100 Mhz is synthesized by aggregating a plurality of continuous or discontinuous carriers, and frequency efficiency of wireless resources is further improved by means of Multiple-Input Multiple-Output (MIMO) techniques applied on uplink and downlink of LTE-A. Thus, the system requirements of IMT-Advanced can be realized in the system of LTE version 10. However, it has been found in actual network deployment and system operation that, in most cases, spectrum competition and scattered available spectrum makes continuous spectrum aggregation on a large-scale unrealistic. In order to achieve the target peak rate of the LTE version 10 system, the future system has to use discontinuous spectrum assigning and bandwidth aggregation. However, there is a significant difference of interference among different frequency bands, especially for network distribution in a TD-LTE system. Therefore, the interference problem between uplink and downlink will seriously restrict TD-LTE system performance.

Based on the analysis above, in the future evolution of TD-LTE, it is an important problem to be considered that different frame structure configurations are used for different Component Carriers (CCs). Especially, in LTE-A version 10, a Heterogeneous Network (Hetnet) system with the same covering for different power nodes is introduced as a technique for significantly improving the system throughput and the overall efficiency of the network. In the Hetnet system, when a UE assigns a plurality of CCs, in order to satisfy the requirement of data services as well as to balance interference of macro-micro cells (e.g. pico cell), a macro-eNB sends downlink control information only on a partial CC configured by the UE to mobilize Physical Resource Blocks (PRB) of all the CCs, without any downlink control information being sent on CCs on which downlink control information of micro-cells is sent to reduce interference to micro-cells. From the perspective of mutual interference between eNBs for analysis, frame structure configuration of the CCs on which downlink control information sent for micro-cells by macro-cells needs to be consistent with that of micro-cells to avoid an uplink-downlink interference problem, while on other discontinuous CCs, macro-cells may use a different frame structure configuration to adapt for a current data service requirement.

FIG. 2 is a schematic diagram illustrating a scenario in which downlink physical resources cannot be used with an existing cross scheduling algorithm according to the prior art.

Referring to FIG. 2, a new CA configuration scenario needs to be discussed in LTE version 11 based on two kinds of analysis.

Assuming that the UE assigns a plurality of CCs, the CCs assigned by the UE are classified as one of two types. One type includes CCs on which the eNB sends downlink control information and downlink packets, which is named a Primary CC (PCC). The other type includes CCs on which the eNB sends downlink packets only, which is named a Secondary CC (SCC). Each PCC and its schedulable SCCs together are called a CC Scheduling Set (CCSS). The eNB uses single downlink control information sent on a single PCC in each CCSS to schedule single downlink sub-frames of a plurality of SCCs in the CCSS. The serial number of SCCs, which carry scheduled downlink physical resources, are indicated by component a Carrier Index Field (CIF) in the downlink control information. Then, based on the above definition and analysis, it needs to be considered in LTE version 11 that in a new configuration scenario, frame structure configurations for PCCs and SCCs in the same CCSS are different, especially for the scenario in which the ratio of downlink sub-frames in the frame structure configuration of the PCC is lower than that of at least one of the SCCs in the same CCSS.

As can be seen clearly from FIG. 2, when the ratio of downlink sub-frames is lower than that of uplink sub-frames in the PCC frame structure configuration in the same CCSS, part of the downlink sub-frames (sub-frames 3, 4, 8 and 9 shown in FIG. 2) in any radio frame of the SCC cannot use its downlink physical resources with the cross-scheduling method introduced in LTE version 10. And, when most UEs in a cell are at a position similar to the interference situation of UE1 as shown in FIG. 2, it leads to a decline of the peak rate of the whole network which makes achievement of the IMT-Advanced system requirement difficult. Accordingly, there is a need for further evolution of LTE version 11.

### SUMMARY OF THE INVENTION

Aspects of the present invention are to address at least the above-mentioned problems and/or disadvantages and to provide at least the advantages described below. Accordingly, an aspect of the present invention is to provide a method for indicating downlink physical resource scheduling in a wireless communication system, in which, when frame structure configurations of Primary Component Carriers (PCCs) and Secondary CCs (SCCs) in the same CC Scheduling Set (CCSS) are different, especially when a ratio of downlink sub-frames in the frame structure configuration of the PCCs is lower than that of at least one of the SCCs of the same CCSS, physical resource scheduling of any downlink sub-frame in the SCCs could be realized, such that a peak rate is able to reach the system design target and International Mobile Telecommunications (IMT)-Advanced system requirement.

Another aspect of the present invention is to provide an apparatus and method for indicating downlink physical resources by an evolved Node B (eNB).

In accordance with an aspect of the present invention, a method for indicating downlink physical resources by an eNB in a wireless communication system is provided. The method includes scheduling physical resources in at least one downlink sub-frame of one of a plurality of CCs through a Carrier Index Field (CIF) in downlink control information, and sending, to a User Equipment (UE), single downlink control information to schedule physical resources in at least one downlink sub-frame of one of the plurality of component carriers at a time, through a sub-frame n of a first CC among the plurality of CCs, wherein the at least one downlink sub-frame includes sub-frames n and (n+2) in each half frame, or sub-frames n and (n+3) in each half frame, and serial numbers of each half frame are started from 0 and have an ascending order.

In accordance with another aspect of the present invention, a method for indicating downlink physical resources in a wireless communication system is provided. The method includes receiving, by a UE, downlink control information, to schedule physical resources in at least one downlink sub-frame of one of a plurality of component carriers at a time, on a first CC among the plurality of CCs, determining the first CC scheduled by the downlink control information according to the value of a CIF in the downlink control information, determining a serial number of the sub-frame in the CC scheduled by the downlink control information according to the value of a multi-sub-frame scheduling field in the downlink control information, and receiving downlink data according to the downlink control information among the plurality of component carriers.

In accordance with another aspect of the present invention, an eNB for indicating downlink physical resources by in a wireless communication system is provided. The eNB includes a scheduler for scheduling physical resources in at least one downlink sub-frame of one of a plurality of component carriers through a CIF in downlink control information, and a sender for sending, to a UE, single downlink control information to schedule physical resources in at least one downlink sub-frame of one of the plurality of component carriers at a time, through a sub-frame n of a first component carrier among the plurality of component carriers, wherein the at least one downlink sub-frame includes sub-frames n and (n+2) in each half frame, or sub-frames n and (n+3) in each half frame, and serial numbers of each half frame are started from 0 and have an ascending order.

In accordance with another aspect of the present invention, a UE for indicating downlink physical resources in a wireless communication system is provided. The user equipment includes a receiver for receiving downlink control information, to schedule physical resources in at least one downlink sub-frame of one of a plurality of CCs at a time, on a first component carrier among the plurality of CCs, and for receiving downlink data according to the downlink control information among the plurality of CCs, and a controller for determining the first CC scheduled by the downlink control information according to the value of a CIF in the downlink control information, and for determining a serial number of the sub-frame in the CC scheduled by the downlink control information according to the value of multi-sub-frame scheduling field in the downlink control information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram illustrating a frame structure configuration of a Time Division (TD)-Long Term Evolution (LTE) system according to the prior art;

FIG. 2 is a schematic diagram illustrating a scenario in which downlink physical resources cannot be used with an existing cross scheduling algorithm according to the prior art;

FIG. 3 is a schematic diagram of existing Component Carriers (CCs) configured by a single User Equipment (UE) according to an exemplary embodiment of the present invention;

FIG. 4 is a schematic diagram of downlink physical resource block scheduling during cross-CC scheduling according to an exemplary embodiment of the present invention;

FIG. 5 is a schematic diagram of cross-CC scheduling according to an exemplary embodiment of the present invention;

FIG. 6 is a schematic diagram of cross-CC scheduling according to an exemplary embodiment of the present invention;

FIG. 7 is a schematic diagram of cross-CC scheduling according to an exemplary embodiment of the present invention;

FIG. 8 is a schematic diagram of expanding downlink control information according to an exemplary embodiment of the present invention;

FIG. 9 is a schematic diagram of a method for scheduling a plurality of downlink sub-frames with a Carrier Index Field (CIF) in single downlink information according to an exemplary embodiment of the present invention;

FIG. 10 is a schematic diagram of a method for scheduling a plurality of downlink sub-frames with a CIF in single downlink information according to an exemplary embodiment of the present invention;

FIG. 11 is a schematic diagram of a method for scheduling a plurality of downlink sub-frames with a CIF in single downlink information according to an exemplary embodiment of the present invention;

FIG. 12 is a schematic diagram of a method for scheduling a plurality of downlink sub-frames with a CIF in single downlink information according to an exemplary embodiment of the present invention;

FIG. 13 is a schematic diagram of a method for scheduling a plurality of downlink sub-frames with a CIF in single downlink information according to an exemplary embodiment of the present invention.

FIG. 14 is a diagram illustrating an evolved Node B (eNB) apparatus according to an exemplary embodiment of the present invention.

FIG. 15 is a diagram illustrating an example of a UE apparatus according to an exemplary embodiment of the present invention.

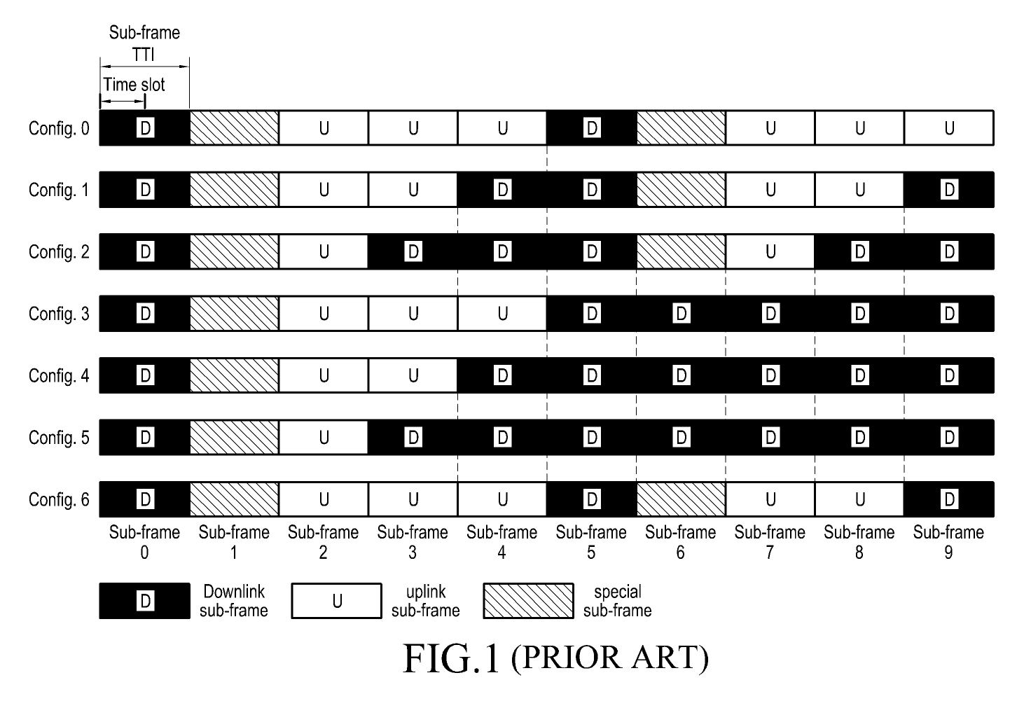

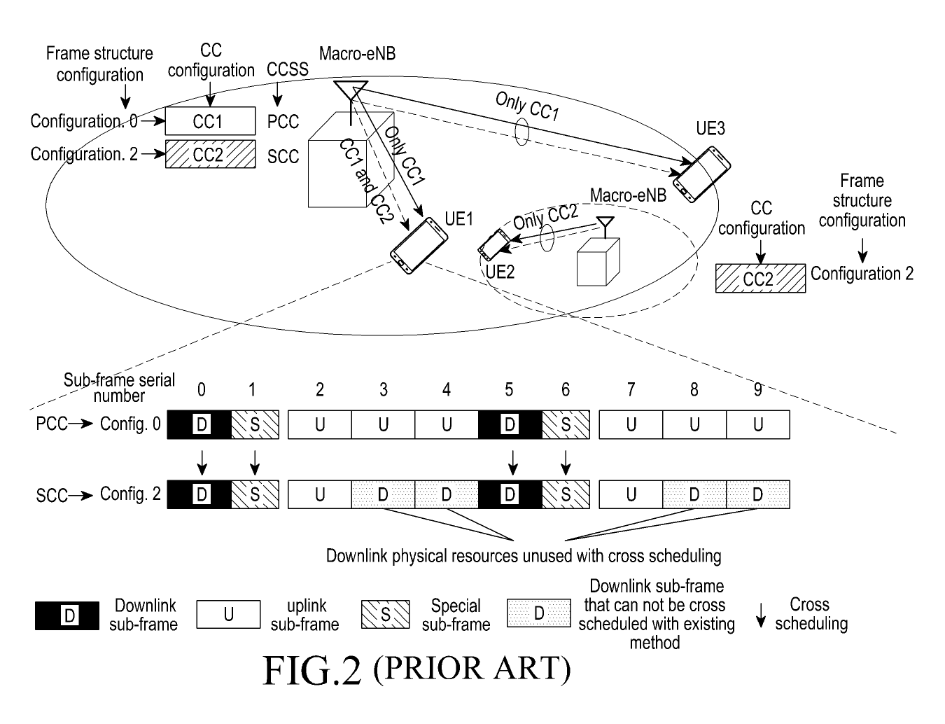

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An exemplary embodiment of the present invention provides a process in which an evolved Node B (eNB) sends downlink control information on a first component carrier to a User Equipment (UE), and schedules physical resources in at least one downlink sub-frame of one of a plurality of component carriers at a time with single downlink control information. Here, the plurality of component carriers comprise the first component carrier, a second component carrier, . . . , and a kth component carrier, wherein k is greater than or equal to 2. After receiving the downlink control information on the first component carrier, the UE can resolve the downlink control information, and receive downlink data according to the result of the resolution.

In an exemplary embodiment of the present invention, if there is no special or alternative explanation, Primary Component Carrier (PCC) refers to the only Component Carrier (CC) for sending downlink control information in any CC Scheduling Set (CCSS) assigned by the UE. That is, PCC represents the first component carrier. Secondary CC (SCC) is used to identify other CC resources in any CCSS configured by the UE except for the PCC. That is, SCC represents the second component carrier. Also, if there is no special or alternative explanation, PCC refers to less than 2. In order to further explain the meanings of PCC and SCC, the following examples are provided.

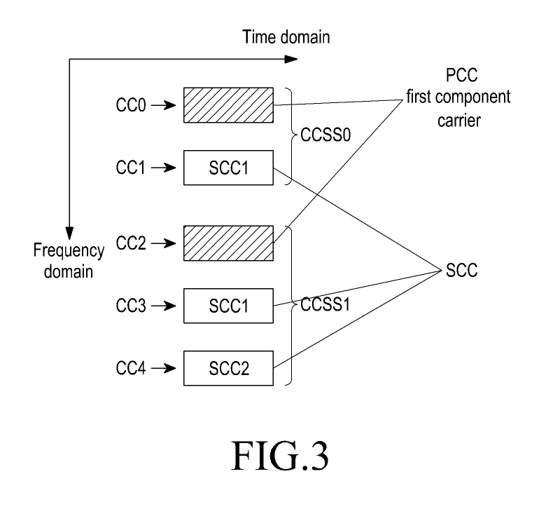

FIG. 3 is a schematic diagram of existing CCs configured by a single UE according to an exemplary embodiment of the present invention.

Referring to FIG. 3, assuming that the UE has configured 5 CCs, which are numbered as CC₀, CC₁, . . . , and CC₄, and the 5 CCs configured by the UE are classified to two CCSS sets, which are CCSS₀ and CCSS₁, the PCC (i.e., the first component carrier) in CCSS₀ is CC_{O3} and the PCC (i.e., the first component carrier) in CCSS₁ is CC₂. When the eNB notifies the UE to support cross-CC scheduling, scheduling information of all the downlink physical resources in CCSS₀ is sent on a special sub-frame of CC₀, and scheduling information of all the downlink physical resources in CCSS₁ is sent on a special sub-frame of CC₂. The UE blindly detects the downlink control information on the PCC (the first component carrier, CC₀ and CC₂ of the present example) of each CCSS to receive the downlink information.

The exemplary method of the present invention can be applied in any CCSS. If there is no special or alternative explanation, CCSS in the following description refers to the same CCSS of a certain UE.

In an exemplary embodiment of the present invention, since single downlink control information could be used to schedule physical resources in at least one downlink sub-frame of a single component carrier at a time, and a plurality of Physical Downlink Control Channels (PDCCHs) could be sent on one PCC, each PDCCH could send one piece of downlink control information on a downlink sub-frame. Then, according to exemplary embodiments of the present invention, physical resources of a plurality of downlink sub-frames of a plurality of component carriers can be scheduled in a single PCC.

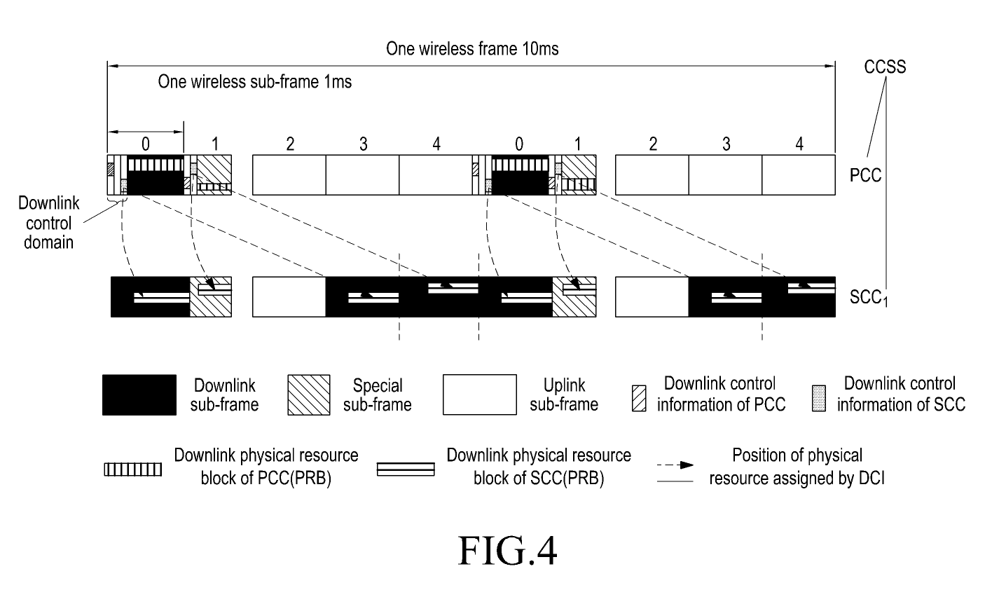

FIG. 4 is a schematic diagram of downlink Physical Resource Block (PRB) scheduling during cross-CC scheduling according to an exemplary embodiment of the present invention.

Referring to FIG. 4, the eNB can schedule physical resources in at least one downlink sub-frame of one of the component carriers of the CCSS by means of the CIF of the existing downlink control information. Alternatively, the eNB introduces a new field to the existing downlink control information and combines the new field and the CIF to schedule physical resources in at least one CC of the CCSS. Accordingly, there are two exemplary embodiments of the present invention, which will be described in more detail as follows.

### First Exemplary Embodiment

In a first exemplary embodiment, only the CIF is used to schedule physical resources of any downlink sub-frame of each SCC in the CCSS. The at least one scheduled downlink sub-frame comprises sub-frame n and sub-frame (n+2) of each half frame, or sub-frame n and sub-frame (n+3) of each half frame. Sub-frames in each half frame are numbered from 0 and are sequentially increased. The downlink control information is sent to the UE via sub-frame n of the PCC. A list of steps in the first exemplary embodiment is hereinafter described.

The first step includes predefining a sub-frame pair in CCSS, and setting correspondence of the number of each component carrier in the CCSS, the number of downlink sub-frames in each CC, and the value of the CIF in the downlink control information.

The second step includes the eNB performing downlink physical resource scheduling in the CCSS, and determining the value of the CIF in the downlink control information according to the number of CCs which the scheduled downlink physical resource belongs to, the number of downlink sub-frames in the CC, and the correspondence preset.

The third step includes the eNB notifying the UE to include the CIF in the downlink control information sent subsequently with Radio Resource Control (RRC) signaling, and sending CCSS configuration information of the UE to the UE. Here, any CCSS configuration information of the UE includes PCC and SCC configured for the UE and the number of each CC.

The fourth step includes the eNB sending the downlink control information of all the CCs in a same CCSS to the UE by the PCC in the CCSS.

The fifth step includes the UE performing blind detection for the downlink control information in a specific downlink sub-frame controlling domain on the primary component carrier PCC, and resolving the CIF in the downlink control information according to the correspondence set in the first step, then receiving and demodulating downlink data according to the resolution result.

In the first step above, when a sub-frame pair is defined, the nth sub-frame and the (n+3)th sub-frame in each half frame could be defined to be a sub-frame pair. As such, the eNB can send the downlink controlling information of the sub-frame pair consisting of the nth sub-frame and the (n+3)th sub-frame in each half frame to the UE through the nth sub-frame of the PCC. Also, the nth sub-frame and the (n+2)th sub-frame in each half frame could be defined to be a sub-frame pair. As such, the eNB can send the downlink controlling information of the sub-frame pair consisting of the nth sub-frame and the (n+2)th sub-frame in each half frame to the UE through the nth sub-frame of the PCC.

In an exemplary implementation, there are 2 sub-frame pairs predefined in each half frame that are represented as Pᵢ(SF_{i,1},SF_{i,2}), in which i=0, 1, which is the serial number of the sub-frame pair. The physical meaning of Pᵢ(SF_{i,1},SF_{i,2}) is that the sub-frame serial number of the sub-frames included in each sub-frame pair Pᵢ are SF_{i,1} and SF_{i,2}, sub-frame and sub-frame SF_{i,2} have an interval of 3 transmitting time intervals, 0≦SF_{i,j}≦4, j=1, 2, the sub-frame in each half frame is numbered from 0, and has an increasing order. In the first step above, the correspondence can be set as follows: if the sub-frame SF_{i,2} of the PCC sub-frame pair Pᵢ(SF_{i,1},SF_{i,2}) is an uplink sub-frame, downlink physical resources in the SCC sub-frame pair Pᵢ(SF_{i,1},SF_{i,2}) are scheduled by the eNB through the sub-frame SF_{i,1} of the PCC of the present CCSS in the same radio frame. Otherwise, the eNB schedules the sub-frame SF_{i,1} through the sub-frame SF_{i,1} of the PCC and schedules the sub-frame SF_{i,2} through the sub-frame SF_{i,2} of the PCC.

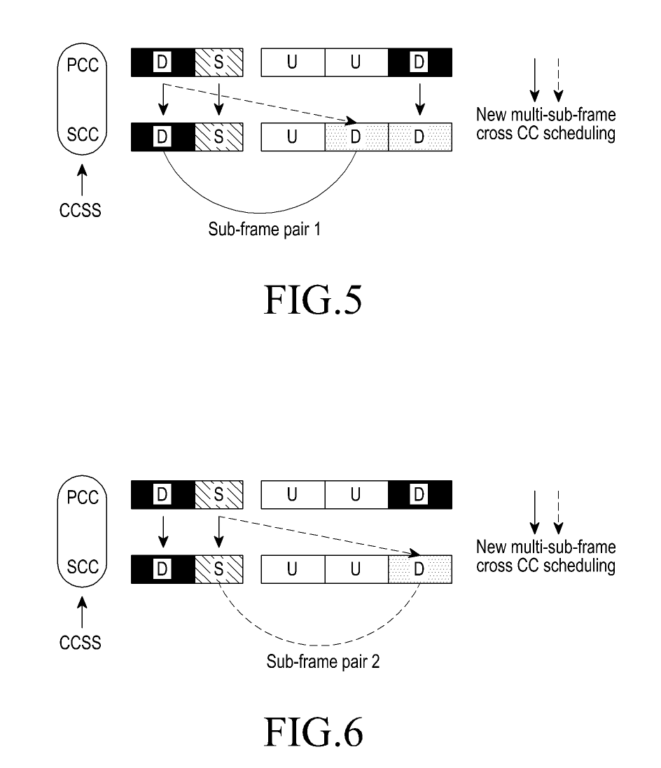

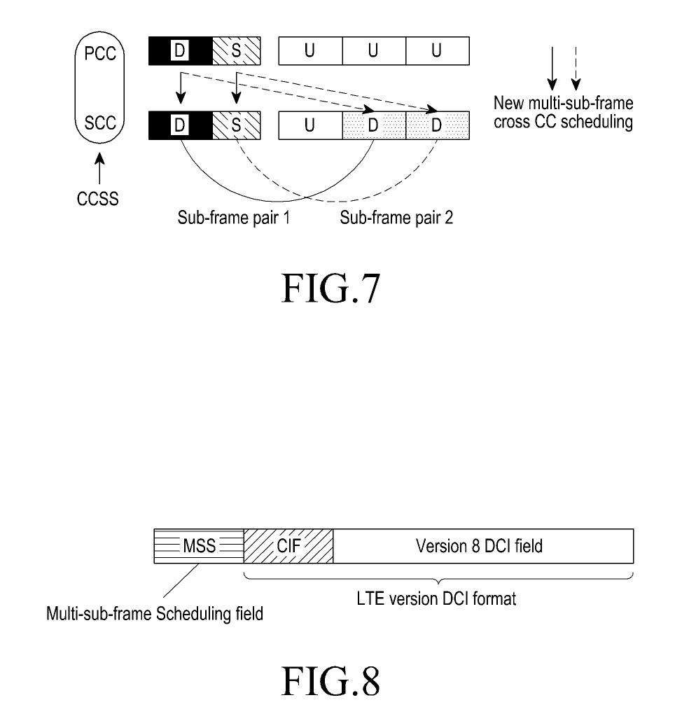

FIG. 5 is a schematic diagram of cross-CC scheduling according to an exemplary embodiment of the present invention. FIG. 6 is a schematic diagram of cross-CC scheduling according to an exemplary embodiment of the present invention. FIG. 7 is a schematic diagram of cross-CC scheduling according to an exemplary embodiment of the present invention.

Referring to FIGS. 5 and 6, the two sub-frame pairs could be set as P₀(0,3) and P₁(1,4) respectively. Here, the cross scheduling shown in FIGS. 5, 6, and 7 could be performed. The sub-frame pairs could also be set as P₀(0,2) and P₁(1,3).

Supposing that the number of CCs in the CCSS is k, the serial number of the PCC is 0, the serial numbers of every SCC are 1, 2, . . . , k−1, each SCC is represented as SCC₁, SCC₂, . . . , SCCₖ₋₁, and the value of the CIF in the downlink control information sent on the sub-frame SF_{i,1} of the PCC is “b₀b₁b₂”, then the correspondence of the first step could be set as explained below.

When k=2 or 3, “b₀b₁b₂”=“000” indicates the corresponding downlink control information to schedule the downlink physical resources of sub-frame SF_{i,1} in the PCC, “b₀b₁b₂”=“001” indicates the corresponding downlink control information to schedule the downlink physical resources of sub-frame SF_{i,1} in the SCC₁, “b₀b₁b₂”=“010” indicates that the corresponding downlink control information is used to schedule the downlink physical resources of sub-frame SF_{i,2} in the SCC₁, and “b₀b₁b₂”=“011” indicates that the corresponding downlink control information is used to schedule the downlink physical resources of sub-frames SF_{i,1} and SF_{i,2} in the SCC₁ at the same time.

When k=3, “b₀b₁b₂”=“100” indicates that the corresponding downlink control information is used to schedule the downlink physical resources of sub-frame SF_{i,1} in the SCC₂, “b₀b₁b₂”=“101” indicates that the corresponding downlink control information is used to schedule the downlink physical resources of sub-frame SF_{i,2} in the SCC₂, and “b₀b₁b₂”=“110” indicates that the corresponding downlink control information is used to schedule the downlink physical resources of sub-frames SF_{i,1} and SF_{i,2} in the SCC₂ at the same time.

When k=4 or 5, “b₀b₁b₂”=“000” indicates that the corresponding downlink control information is used to schedule the downlink physical resources of sub-frame SF_{i,1} in the PCC, “b₀b₁b₂”=“001” indicates that the corresponding downlink control information is used to schedule the downlink physical resources of sub-frame SF_{i,1} in the SCC₁, “b₀b₁b₂”=“010” indicates that the corresponding downlink control information is used to schedule the downlink physical resources of sub-frame SF_{i,2} in the SCC₁, “b₀b₁b₂”=“011” indicates that the corresponding downlink control information is used to schedule the downlink physical resources of sub-frame SF_{i,1} in the SCC₂, “b₀b₁b₂”=“100” indicates that the corresponding downlink control information is used to schedule the downlink physical resources of sub-frame SF_{i,2} in the SCC₂, “b₀b₁b₂”=“101” indicates that the corresponding downlink control information is used to schedule the downlink physical resources of sub-frame SF_{i,1} in the SCC₃, and “b₀b₁b₂”=“110” indicates that the corresponding downlink control information is used to schedule the downlink physical resources of sub-frame SF_{i,2} in the SCC₃.

When k=5, “b₀b₁b₂”=“111” indicates that the corresponding downlink control information is used to schedule the downlink physical resources of sub-frame SF_{i,1} in the SCC₄.

A chart of the above explained correspondence is expressed in Table 1.

TABLE 1

| | | Quantity of CC in CCSS | | | |
|---|---|---|---|---|---|
| CIF | | 2 | 3 | 4 | 5 |
| 000 | Serial number | PCC | | | |
| | of CC | | | | |
| | scheduled | | | | |
| | Serial number | SF_{i, 1} | | | |
| | of sub-frame | | | | |
| | scheduled | | | | |
| 001 | Serial number | SCC1 | | | |
| | of CC | | | | |
| | scheduled | | | | |
| | Serial number | SF_{i, 1} | | | |
| | of sub-frame | | | | |
| | scheduled | | | | |
| 010 | Serial number | SCC1 | | | |
| | of CC | | | | |
| | scheduled | | | | |
| | Serial number | SF_{i, 2} | | | |
| | of sub-frame | | | | |
| | scheduled | | | | |
| 011 | Serial number | SCC1 | | SCC2 | |
| | of CC | | | | |
| | scheduled | | | | |
| | Serial number | SF_{i, 1} and SF_{i, 2} | | SF_{i, 1} | |
| | of sub-frame | | | | |
| | scheduled | | | | |
| 100 | Serial number | Reserved | SCC2 | SCC2 | |
| | of CC | | | | |
| | scheduled | | | | |
| | Serial number | | SF_{i, 1} | SF_{i, 2} | |
| | of sub-frame | | | | |
| | scheduled | | | | |
| 101 | Serial number | | SCC2 | SCC3 | |
| | of CC | | | | |
| | scheduled | | | | |
| | Serial number | | SF_{i, 2} | SF_{i, 1} | |
| | of sub-frame | | | | |
| | scheduled | | | | |
| 110 | Serial number | | SCC2 | SCC3 | |
| | of CC | | | | |
| | scheduled | | | | |
| | Serial number | | SF_{i, 1} and SF_{i, 2} | SF_{i, 2} | |
| | of sub-frame | | | | |
| | scheduled | | | | |
| 111 | Serial number | | Reserved | Reserved | SCC4 |
| | of CC | | | | |
| | scheduled | | | | |
| | Serial number | | | | SF_{i, 1} |
| | of sub-frame | | | | |
| | scheduled | | | | |

In addition, based on an exemplary embodiment of the present invention, correspondence can also be set as shown in Tables 2 and 3.

TABLE 2

| | | Quantity of CC in CCSS | | | |
|---|---|---|---|---|---|
| CIF | | 2 | 3 | 4 | 5 |
| 000 | Serial number | PCC | | | |
| | of CC | | | | |
| | scheduled | | | | |
| | Serial number | SF_{i, 1} | | | |
| | of sub-frame | | | | |
| | scheduled | | | | |
| 001 | Serial number | SCC₁ | | | |
| | of CC | | | | |
| | scheduled | | | | |
| | Serial number | SF_{i, 1} | | | |
| | of sub-frame | | | | |
| | scheduled | | | | |
| 010 | Serial number | SCC₁ | | | |
| | of CC | | | | |
| | scheduled | | | | |
| | Serial number | SF_{i, 2} | | | |
| | of sub-frame | | | | |
| | scheduled | | | | |
| 011 | Serial number | SCC₁ | | | |
| | of CC | | | | |
| | scheduled | | | | |
| | Serial number | SF_{i, 1} and SF_{i, 2} | | | |
| | of sub-frame | | | | |
| | scheduled | | | | |
| 100 | Serial number | Reserved | SCC₂ | | |
| | of CC | | | | |
| | scheduled | | | | |
| | Serial number | | SF_{i, 1} | | |
| | of sub-frame | | | | |
| | scheduled | | | | |
| 101 | Serial number | | SCC₂ | | |
| | of CC | | | | |
| | scheduled | | | | |
| | Serial number | | SF_{i, 2} | | |
| | of sub-frame | | | | |
| | scheduled | | | | |
| 110 | Serial number | | SCC₂ | SCC₃ | |
| | of CC | | | | |
| | scheduled | | | | |
| | Serial number | | SF_{i, 1} and SF_{i, 2} | SF_{i, 1} | |
| | of sub-frame | | | | |
| | scheduled | | | | |
| 111 | Serial number | | Reserved | SCC₃ | SCC₄ |
| | of CC | | | | |
| | scheduled | | | | |
| | Serial number | | | SF_{i, 2} | SF_{i, 1} |
| | of sub-frame | | | | |
| | scheduled | | | | |

An explanation of the physical meaning of Table 2 is provided below.

Supposing that the number of CCs in the CCSS is k, the serial number of the PCC is 0, the serial numbers of every SCC are 1, 2, . . . , k−1, each SCC is represented as SCC₁, SCC₂, . . . , SCCₖ₋₁, and the value of the CIF in the downlink control information sent on the sub-frame SF_{i,1} of the PCC is “b₀b₁b₂”, then the correspondence of the first step could be set as described below.

When k≧2, “b₀b₁b₂”=“000” indicates that the corresponding downlink control information is used to schedule the downlink physical resources of sub-frame SF_{i,1} in the PCC, “b₀b₁b₂”=“001” indicates that the corresponding downlink control information is used to schedule the downlink physical resources of sub-frame SF_{i,1} in the SCC₁, “b₀b₁b₂”=“010” indicates that the corresponding downlink control information is used to schedule the downlink physical resources of sub-frame SF_{i,2} in the SCC₁, and “b₀b₁b₂”=“011” indicates that the corresponding downlink control information is used to schedule the downlink physical resources of sub-frames SF_{i,1} and SF_{i,2} in the SCC₁ at the same time.

When k≧3, “b₀b₁b₂”=“100” indicates that the corresponding downlink control information is used to schedule the downlink physical resources of sub-frame SF_{i,1} in the SCC₂, and “b₀b₁b₂”=“101” indicates that the corresponding downlink control information is used to schedule the downlink physical resources of sub-frame SF_{i,2} in the SCC₂.

When k=3, “b₀b₁b₂”=“110” indicates that the corresponding downlink control information is used to schedule the downlink physical resources of sub-frames SF_{i,1} and SF_{i,2} in the SCC₂.

When k=4, “b₀b₁b₂”=“110” indicates that the corresponding downlink control information is used to schedule the downlink physical resources of sub-frame SF_{i,2} in the SCC₃.

When k=4, “b₀b₁b₂”=“111” indicates that the corresponding downlink control information is used to schedule the downlink physical resources of sub-frame SF_{i,2} in the SCC₃.

When k=5, “b₀b₁b₂”=“111” indicates that the corresponding downlink control information is used to schedule the downlink physical resources of sub-frame SF_{i,1} in the SCC₄.

TABLE 3

| | | Quantity of CC in CCSS | | | |
|---|---|---|---|---|---|
| CIF | | 2 | 3 | 4 | 5 |
| 000 | Serial number | PCC | | | |
| | of CC | | | | |
| | scheduled | | | | |
| | Serial number | SF_{i, 1} | | | |
| | of sub-frame | | | | |
| | scheduled | | | | |
| 001 | Serial number | SCC₁ | | | |
| | of CC | | | | |
| | scheduled | | | | |
| | Serial number | SF_{i, 1} | | | |
| | of sub-frame | | | | |
| | scheduled | | | | |
| 010 | Serial number | SCC₁ | | | |
| | of CC | | | | |
| | scheduled | | | | |
| | Serial number | SF_{i, 2} | | | |
| | of sub-frame | | | | |
| | scheduled | | | | |
| 011 | Serial number | SCC₁ | | | |
| | of CC | | | | |
| | scheduled | | | | |
| | Serial number | SF_{i, 1} and SF_{i, 2} | | | |
| | of sub-frame | | | | |
| | scheduled | | | | |
| 100 | Serial number | Reserved | SCC₂ | | |
| | of CC | | | | |
| | scheduled | | | | |
| | Serial number | | SF_{i, 1} | | |
| | of sub-frame | | | | |
| | scheduled | | | | |
| 101 | Serial number | | SCC₂ | | |
| | of CC | | | | |
| | scheduled | | | | |
| | Serial number | | SF_{i, 2} | | |
| | of sub-frame | | | | |
| | scheduled | | | | |
| 110 | Serial number | | SCC₂ | | SCC₃ |
| | of CC | | | | |
| | scheduled | | | | |
| | Serial number | | SF_{i, 1} and SF_{i, 2} | | SF_{i, 1} |
| | of sub-frame | | | | |
| | scheduled | | | | |
| 111 | Serial number | | Reserved | SCC₃ | SCC₄ |
| | of CC | | | | |
| | scheduled | | | | |
| | Serial number | | | SF_{i, 1} | SF_{i, 1} |
| | of sub-frame | | | | |
| | scheduled | | | | |

An explanation of the physical meaning of Table 3 is provided below.

Supposing that the number of CCs in the CCSS is k, the serial number of the PCC is 0, the serial numbers of every SCC are 1, 2, . . . , k−1, each SCC is represented as SCC₁, SCC₂, . . . , SCCₖ₋₁, and the value of the CIF in the downlink control information sent on the sub-frame SF_{i,1} of the PCC is “b₀b₁b₂”, then the correspondence of the first step could be set as described below.

When k≧2, “b₀b₁b₂”=“000” indicates that the corresponding downlink control information is used to schedule the downlink physical resources of sub-frame SF_{i,1} in the PCC, “b₀b₁b₂”=“001” indicates that the corresponding downlink control information is used to schedule the downlink physical resources of sub-frame SF_{i,1} in the SCC₁, “b₀b₁b₂”=“010” indicates that the corresponding downlink control information is used to schedule the downlink physical resources of sub-frame SF_{i,2} in the SCC₁, and “b₀b₁b₂”=“011” indicates that the corresponding downlink control information is used to schedule the downlink physical resources of sub-frames SF_{i,1} and SF_{i,2} in the SCC₁.

When k≧3, “b₀b₁b₂”=“100” indicates that the corresponding downlink control information is used to schedule the downlink physical resources of sub-frame SF_{i,1} in the SCC₂, and “b₀b₁b₂”=“101” indicates that the corresponding downlink control information is used to schedule the downlink physical resources of sub-frame SF_{i,2} in the SCC₂.

When k=3 or k=4 “b₀b₁b₂”=“110” indicates that the corresponding downlink control information is used to schedule the downlink physical resources of sub-frames SF_{i,1} and SF_{i,2} in the SCC₂.

When k=4, “b₀b₁b₂”=“111” indicates that the corresponding downlink control information is used to schedule the downlink physical resources of sub-frame SF_{i,1} in the SCC₃.

When k=5, “b₀b₁b₂”=“110” indicates that the corresponding downlink control information is used to schedule the downlink physical resources of sub-frame SF_{i,1} in the SCC₃, and “b₀b₁b₂”=“111” indicates that the corresponding downlink control information is used to schedule the downlink physical resources of sub-frame SF_{i,1} in the SCC₄.

### Second Exemplary Embodiment

In a second exemplary embodiment, a new field is expanded in the downlink control information and is referred to as the Multi-Sub-frame Scheduling (MMS) field. The MMS field and the CIF may be combined to realize the physical resource scheduling of any sub-frame in each SCC in CCSS.

FIG. 8 is a schematic diagram of expanding downlink control information according to an exemplary embodiment of the present invention.

Referring to FIG. 8, the value of CIF in the downlink control information is used to determine the scheduled component carrier, and the value of the MMS field is used to determine a scheduled downlink sub-frame in the scheduled component carrier.

In an exemplary embodiment, predefining a sub-frame pair in the CCSS includes defining a sub-frame pair i, which is represented as Bᵢ(PSFᵢ, SSFᵢ⁰, SSFᵢ¹, . . . , SSFᵢ^{k-2}), i>0, k≧2 wherein k is the sub-frame pair quantity included in a sub-frame pair, all of the sub-frames in a same sub-frame pair are in a same radio frame, SSFᵢ^{j}, 0≦j<k−1, are in the SCC of a same CCSS, and the serial number of the SCC is indicated by the CIF in the downlink control information.

When correspondence of CC serial numbers, serial numbers of downlink sub-frames in each CC, and values of the CIF and the MMS in the downlink control are set, the following process may be used: setting correspondence of the CC serial number and the value of the CIF, and setting correspondence between each bit of multi-sub-frame in the downlink control information sent on the sub-frame PSFᵢ of the PCC and each sub-frame in the sub-frame pair Bᵢ(PSFᵢ, SSFᵢ⁰, SSFᵢ¹, . . . , SSFᵢ^{k-1}), in which the bit-width of multi-sub-frame scheduling is k. In this manner, the eNB sends downlink control information of all the sub-frames in sub-frame pair Bᵢ to the UE through the sub-frame PSFᵢ in the sub-frame pair. The UE resolves the downlink i physical resources scheduling field in the following manner: firstly, determining the serial number of the CC scheduled by the downlink control information according to the value of the CIF in the downlink control information, then determining the sub-frame serial number in the CC scheduled by the downlink control information according to the value of the multi-sub-frame scheduling field in the downlink control information.

Supposing that the multi-sub-frame scheduling field is indicated by a symbol <b₀ b₁ b₂ . . . bₖ₋₁>, in which bₘ, 0≦m<k is used to indicate whether the downlink control information including the multi-sub-frame scheduling field fits for the sub-frame SSFᵢ^{m}, 0≦m<k in Bᵢ(PSFᵢ, SSFᵢ⁰, SSFᵢ¹, . . . , SSFᵢ^{k-1}), in it can be defined that “bₘ=1” indicates that the downlink control information including the multi-sub-frame scheduling field is used to schedule the downlink physical resources of the sub-frame SSFᵢ^{m}, 0≦m<k, and that “bₘ=0” indicates that the downlink control information including the multi-sub-frame scheduling field is not used to schedule the downlink physical resources of the sub-frame SSFᵢ^{m}, 0≦m<k, or vice versa.

An exemplary method for indicating downlink physical resources scheduling in a wireless communication system has been described above. For further explanation of exemplary embodiments of the present invention, the following five examples are provided.

### The First Example

As part of the first example, several assumptions are made as described below.

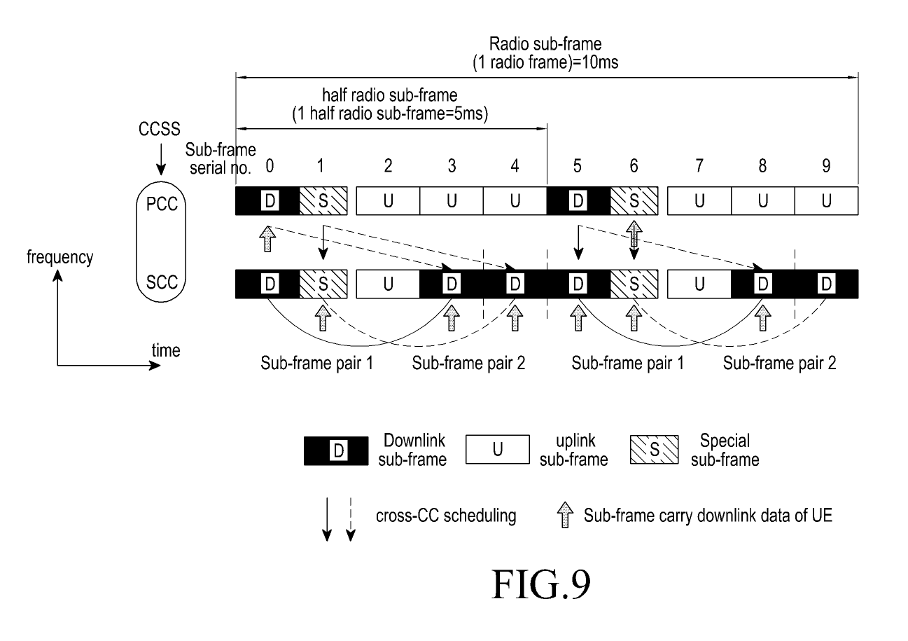

FIG. 9 is a schematic diagram of a method for scheduling a plurality of downlink sub-frames with a Carrier Index Field (CIF) in single downlink information according to an exemplary embodiment of the present invention.

It is assumed that there are 5 CCs in the cell and the number of CCs configured for the UE is k, k≦5. In the present example, k=2, and the CCs assigned are marked as CC₀ and CC₁.

The eNB notifies the UE of its CCSS configuration information through RRC signaling. Here, the CCSS configuration information is that the CCs assigned by the UE are classified to be a CCSS, in which CC₀ is the PCC of the CCSS, and CC₁ is the SCC of the CCSS (as shown in FIG. 9). The eNB uses configuration 0 of frame structure type 2 on CC₀ and configuration 2 of frame structure type 2 on CC₁.

In this example, the eNB reaches a desired target in that single downlink control information schedules multiple downlink sub-frames in the SCC, with the CIF in the downlink control information, and the meaning of the CIF is shown in Table 1.

In this example, in the radio frame observed, according to the scheduling algorithm of the eNB and service situation of the UE, the eNB determines to send downlink packets of the UE on sub-frame 0 and sub-frame 6 of the PCC, and to send downlink packets of the UE on sub-frames 1, 3, 4, 5, 6 and 8 of the SCC. An exemplary method for scheduling downlink physical resources is described below.

Step 1: the system predefines the quantity and correspondence of sub-frame pairs Pᵢ(SF_{i,1},SF_{i,2}) in a single half frame. In this example, the correspondence predefined by the system is that there are 2 sub-frame pairs in a single half frame which are P₀(0,3) and P₁(1,4).

Step 2: the eNB informs the UE to turn on the function of cross-CC scheduling.

Step 3: the eNB schedules the CC position and sub-frame serial numbers according to its requirement based on existing rules of LTE version 10, and generates each field besides the CIF of the Downlink Control Information (DCI). Assuming that the DCI generated is marked as DCI_{SI}^{CI}, in which CI represents the serial number of the CC where physical resources scheduled by DCI_{SI}^{CI} are located, and, in this example, CI=0 represents the PCC and CI=1 represents the SCC. Also, SI represents the serial number of the sub-frame in the CC indicated by CI in DCI_{SI}^{CI}. Here, SI can be a serial number of a single sub-frame, or the two sub-frames in the sub-frame pair defined in Step 1.

In the present example, according to the scheduling algorithm of eNB and an exemplary embodiment of the present invention, correspondence between downlink control information DCI_{SI}^{CI} sent in different sub-frames of the PCC and the CIF included therein is shown in Table 4.

TABLE 4

| Sub-frame serial number | | | | | | | | | | | | | |
|---|---|---|---|---|---|---|---|---|---|---|---|---|---|
| 0 | | 1 | | | | | 5 | | 6 | | | | |
| CIF | DCI | CIF | DCI | 2 | 3 | 4 | CIF | DCI | CIF | DCI | 7 | 8 | 9 |

| | | | | | | | | |
|---|---|---|---|---|---|---|---|---|
| PCC | 000 | DCI₀⁰ | | | | | 000 | DCI₆⁰ |
| | 010 | DCI₃¹ | 011 | DCI_{1, 4}¹ | 011 | DCI_{5, 8}¹ | 001 | DCI₆¹ |

Step 4: the UE blindly detects downlink control information in all the downlink control sub-frames in the PCC, determines the CC serial number and the sub-frame serial number of the downlink physical resources scheduled by the downlink control information according to the value of the CIF in the downlink control information, and receives downlink data accordingly.

### The Second Example

As part of the second example, several assumptions are made as described below.

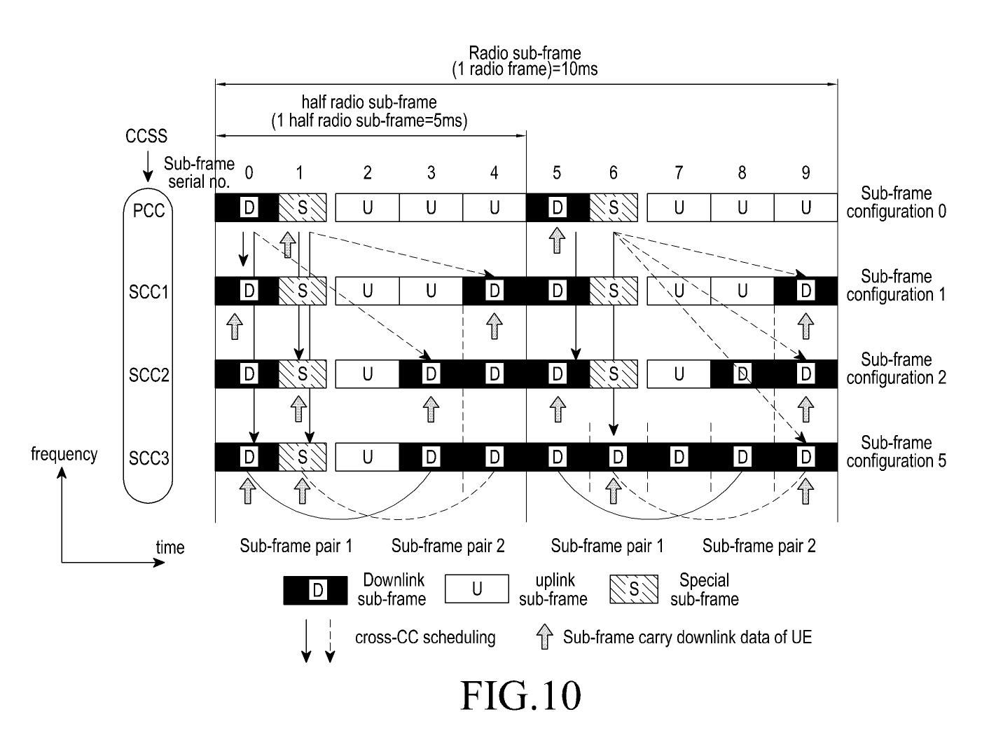

FIG. 10 is a schematic diagram of a method for scheduling a plurality of downlink sub-frames with the CIF in single downlink information according to an exemplary embodiment of the present invention.

It is assumed that there are 5 CCs in the cell and the number of CCs configured for the UE is k, k≦5. In the present example, k=4, and the CCs assigned are marked as CCᵢ, i=0, 1, 2, 3.

The eNB notifies the UE its CCSS configuration information through RRC signaling. Here, the CCSS configuration information is that the CCs assigned by the UE are classified to be a CCSS, in which CC₀ is the PCC of the CCSS, and CCⱼ, 1≦j≦3 is correspondingly mapped to be SCC, of the CCSS. The eNB uses configuration 0 of frame structure type 2 on CC_{O3} configuration 1 of frame structure type 2 on CC₁, configuration 2 of frame structure type 2 on CC₁ and configuration 5 of frame structure type 2 on CC₃ (as shown in FIG. 10).

In this example, the eNB reaches a desired target in that single downlink control information schedules multiple downlink sub-frames in the SCC, with the CIF in the downlink control information, and the meaning of the CIF is shown in Table 1.

In this example, in the radio frame observed, according to the scheduling algorithm of the eNB and service situation of the UE, the eNB determines to send downlink packets of the UE on sub-frame 1 and sub-frame 5 of the PCC, and to send downlink packets of the UE on sub-frames 0, 4 and 9 of SCC₁, sub-frames 1, 3, 5 and 9 of SCC₂, and sub-frames 0, 1 and 6 of SCC₃. An exemplary method for scheduling downlink physical resources is described below.

Step 1: the system predefines the quantity and correspondence of sub-frame pairs Pᵢ(SF_{i,1},SF_{i,2}) in a single half frame. In this example, the correspondence predefined by the system is that there are 2 sub-frame pairs in a single half frame which are P₀(0,3) and P₁(1,4).

Step 2: the eNb informs the UE to turn on the function of cross-CC scheduling.

Step 3: the eNB schedules CC position and sub-frame serial numbers according to its requirement based on existing rules of LTE version 10, and generates each field besides the CIF of the DCI. Assuming that the DCI generated is marked as DCI_{SI}^{CI}, in which CI represents the serial number of the CC where physical resources scheduled by DCI_{SI}^{CI} are located, and, in this example, CI=0 represents the PCC and CI≧1 represents the SCC. Also, SI represents the serial number of the sub-frame in the CC indicated by CI in DCI_{SI}^{CI}. Here, SI can be a serial number of a single sub-frame, or the two sub-frames in the sub-frame pair defined in Step 1.

In the present example, according to the scheduling algorithm of eNB and an exemplary embodiment of the present invention, correspondence between downlink control information DCI_{SI}^{CI} sent in different sub-frames of the PCC and the CIF included therein is shown in Table 5.

TABLE 5

| Sub-frame serial number | | | | | | | | | | | | | |
|---|---|---|---|---|---|---|---|---|---|---|---|---|---|
| 0 | | 1 | | | | | 5 | | 6 | | | | |
| CIF | DCI | CIF | DCI | 2 | 3 | 4 | CIF | DCI | CIF | DCI | 7 | 8 | 9 |

| | | | | | | | | |
|---|---|---|---|---|---|---|---|---|
| PCC | | | 000 | DCI₁⁰ | 000 | DCI₅⁰ | | |
| | 001 | DCI₀¹ | 010 | DCI₄¹ | | | 010 | DCI₉¹ |
| | 100 | DCI₃² | 011 | DCI₁² | 011 | DCI₅² | 100 | DCI₉² |
| | 101 | DCI₀³ | 101 | DCI₁³ | | | 101 | DCI₆³ |

Step 4: the UE blindly detects downlink control information in all the downlink control sub-frames in the PCC, determines the CC serial number and the sub-frame serial number of the downlink physical resources scheduled by the DCI according to the value of the CIF in the downlink control information, and receives downlink data accordingly.

### The Third Example

As part of the third example, several assumptions are made as described below.

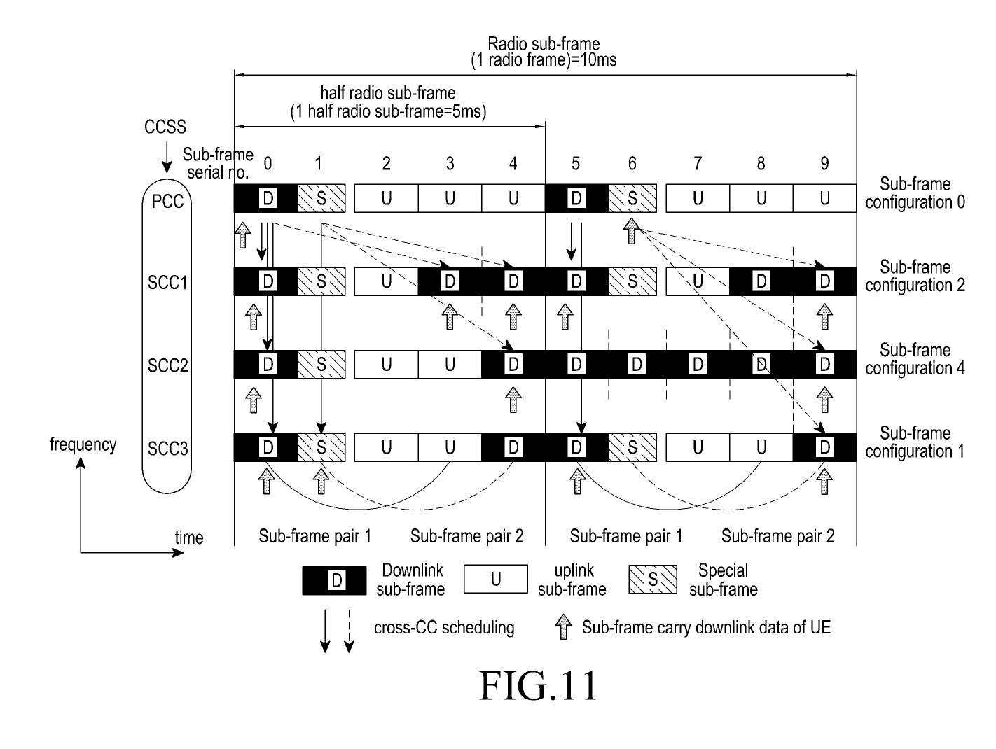

FIG. 11 is a schematic diagram of a method for scheduling a plurality of downlink sub-frames with the CIF in single downlink information according to an exemplary embodiment of the present invention.

It is assumed that there are 5 CCs in the cell, and the number of CCs configured for the UE is k, k≦5. In the present example, k=4, and the CCs assigned are marked as CCᵢ, i=0, 1, 2, 3.

The eNB notifies the UE of its CCSS configuration information through RRC signaling. Here, the CCSS configuration information is that the CCs assigned by the UE are classified to be a CCSS, in which CC₀ is the PCC of the CCSS, and CCⱼ, 1≦j≦3 is correspondingly mapped to be SCCⱼ of the CCSS. The eNB uses configuration 2 of frame structure type 2 on CC₀, configuration 2 of frame structure type 2 on CC₁, configuration 4 of frame structure type 2 on CC₂ and configuration 1 of frame structure type 2 on CC₃ (as shown in FIG. 11).

In this example, the eNB reaches a desired target in that single downlink control information schedules multiple downlink sub-frames in the SCC, with the CIF in the downlink control information, and the meaning of the CIF is shown in Table 2.

In this example, in the radio frame observed, according to the scheduling algorithm of the eNB and service situation of the UE, the eNB determines to send downlink packets of the UE on sub-frame 0 and sub-frame 6 of the PCC, and to send downlink packets of the UE on sub-frames 0, 3, 4, 5 and 9 of SCC₁, sub-frames 0, 4 and 9 of SCC₂, and sub-frames 0, 1, 5 and 9 of SCC₃. An exemplary method for scheduling downlink physical resources is described below.

Step 1: the system predefines the quantity and correspondence of sub-SP frame pairs Pᵢ(SF_{i,1},SF_{i,2}) in a single half frame. In this example, the correspondence predefined by the system is that there are 2 sub-frame pairs in a single half frame which are P₀(0,3) and P₁(1,4).

Step 2: the eNB informs the UE to turn on the function of cross-CC scheduling.

Step 3: the eNB schedules the CC position and sub-frame serial numbers according to its requirement based on existing rules of LTE version 10, and generates each field besides the CIF of the DCI. Assuming that the DCI generated is marked as DCI_{SI}^{CI}, in which CI represents the serial number of the CC where physical resources scheduled by DCI_{SI}^{CI} are located, and, in this example, CI=0 represents the PCC and CI≧1 represents the SCC. Also, SI represents the serial number of the sub-frame in the CC indicated by CI in DCI_{SI}^{CI}. Here, SI can be a serial number of a single sub-frame, or the two sub-frames in the sub-frame pair defined in Step 1.

In the present example, according to the scheduling algorithm of eNB and an exemplary embodiment of the present invention, correspondence between downlink control information DCI_{SI}^{CI} sent in different sub-frames of the PCC and the CIF included therein is shown in Table 6.

TABLE 6

| Sub-frame serial number | | | | | | | | | | | | | |
|---|---|---|---|---|---|---|---|---|---|---|---|---|---|
| 0 | | 1 | | | | | 5 | | 6 | | | | |
| CIF | DCI | CIF | DCI | 2 | 3 | 4 | CIF | DCI | CIF | DCI | 7 | 8 | 9 |

| | | | | | | | | |
|---|---|---|---|---|---|---|---|---|
| PCC | 000 | DCI₀⁰ | | | | | 000 | DCI₆⁰ |
| | 011 | DCI_{0, 3}¹ | 010 | DCI₄¹ | 001 | DCI₅¹ | 010 | DCI₉¹ |
| | 100 | DCI₀² | 101 | DCI₄² | | | 101 | DCI₉² |
| | 110 | DCI₀³ | 110 | DCI₁³ | 110 | DCI₅³ | 111 | DCI₉³ |

Step 4: the UE blindly detects downlink control information in all the downlink control sub-frames in the PCC, determines the CC serial number and the sub-frame serial number of the downlink physical resources scheduled by the DCI according to the value of the CIF in the downlink control information, and receives downlink data accordingly.

### The Fourth Example

As part of the fourth example, several assumptions are made as described below.

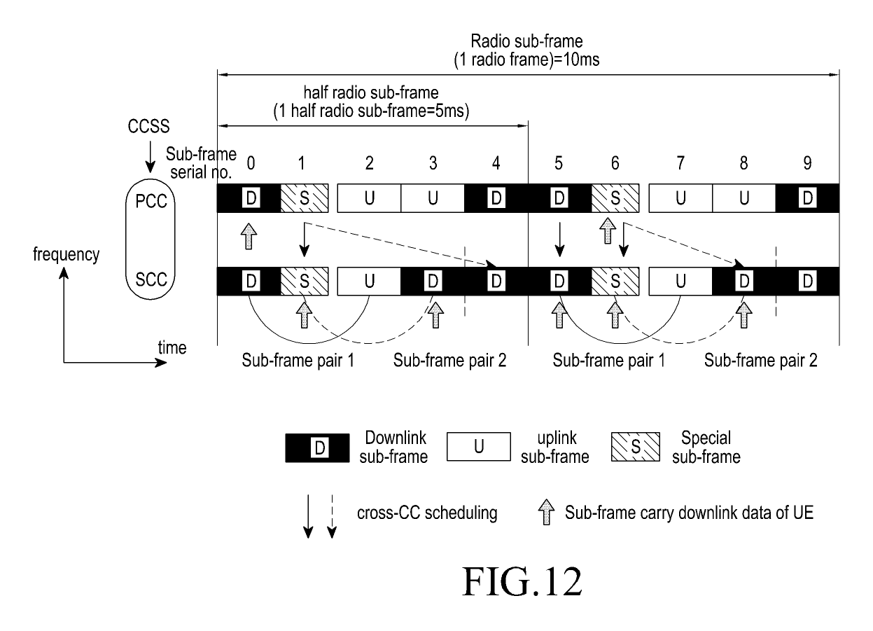

FIG. 12 is a schematic diagram of a method for scheduling a plurality of downlink sub-frames with the CIF in single downlink information according to an exemplary embodiment of the present invention.

It is assumed that there are 5 CCs in the cell and the number of CCs configured for the UE is k, k≦5. In the present example, k=2, and the CCs assigned are marked as CC₀ and CC₁.

The eNB notifies the UE of its CCSS configuration information through RRC signaling. Here, the CCSS configuration information is that the CCs assigned by the UE are classified to be a CCSS, in which CC₀ is the PCC of the CCSS, and CC₁ is the SCC of the CCSS (as shown in FIG. 12). The eNB uses configuration 1 of frame structure type 2 on CC₀ and configuration 2 of frame structure type 2 on CC₁.

In this example, the eNB reaches a desired target in that single downlink control information schedules multiple downlink sub-frames in the SCC, with the CIF in the downlink control information, and the meaning of the CIF is shown in Table 1.

In this example, in the radio frame observed, according to the scheduling algorithm of the eNB and service situation of the UE, the eNB determines to send downlink packets of the UE on sub-frame 0 and sub-frame 6 of the PCC, and to send downlink packets of the UE on sub-frames 1, 3, 5, 6 and 8 of the SCC. An exemplary method for scheduling downlink physical resources is described below.

Step 1: the system predefines the quantity and correspondence of sub-frame pairs Pᵢ(SF_{i,1},SF_{i,2}) in a single half frame. In this example, the correspondence predefined by the system is that there are 2 sub-frame pairs in a single half frame which are P₀(0,2) and P₁(1,3), the interval of the sub-frame pairs is 2.

Step 2: the eNb informs the UE to turn on the function of cross-CC scheduling.

Step 3: the eNB schedules the CC position and sub-frame serial numbers according to its requirement based on existing rules of LTE version 10, and generates each field besides the CIF of the DCI. Assuming that the DCI generated is marked as DCI_{SI}^{CI}, in which CI represents the serial number of the CC where physical resources scheduled by DCI_{SI}^{CI} are located, and, in this example, CI=0 represents the PCC and CI=1 represents the SCC. Also, SI represents the serial number of sub-frame in the CC indicated by CI in DCI_{SI}^{CI}. Here, SI can be a serial number of a single sub-frame, or the two sub-frames in the sub-frame pair defined in Step 1.

In the present example, according to the scheduling algorithm of eNB and an exemplary embodiment of the present invention, correspondence between downlink control information DCI_{SI}^{CI} sent in different sub-frames of the PCC and the CIF included therein is shown in Table 7.

TABLE 7

| Sub-frame serial number | | | | | | | | | | | | | |
|---|---|---|---|---|---|---|---|---|---|---|---|---|---|
| 0 | | 1 | | | | | 5 | | 6 | | | | |
| CIF | DCI | CIF | DCI | 2 | 3 | 4 | CIF | DCI | CIF | DCI | 7 | 8 | 9 |

| | | | | | | | | |
|---|---|---|---|---|---|---|---|---|
| PCC | 000 | DCI₀⁰ | | | | | 000 | DCI₆⁰ |
| | | | 011 | DCI_{1, 3}¹ | 001 | DCI₅¹ | 011 | DCI_{6, 8}¹ |

Step 4: the UE blindly detects downlink control information in all the downlink control sub-frames in the PCC, determines the CC serial number and the sub-frame serial number of the downlink physical resources scheduled by the downlink control information according to the value of the CIF in the downlink control information, and receives downlink data accordingly.

### The Fifth Example

As part of the fifth example, several assumptions are made as described below.

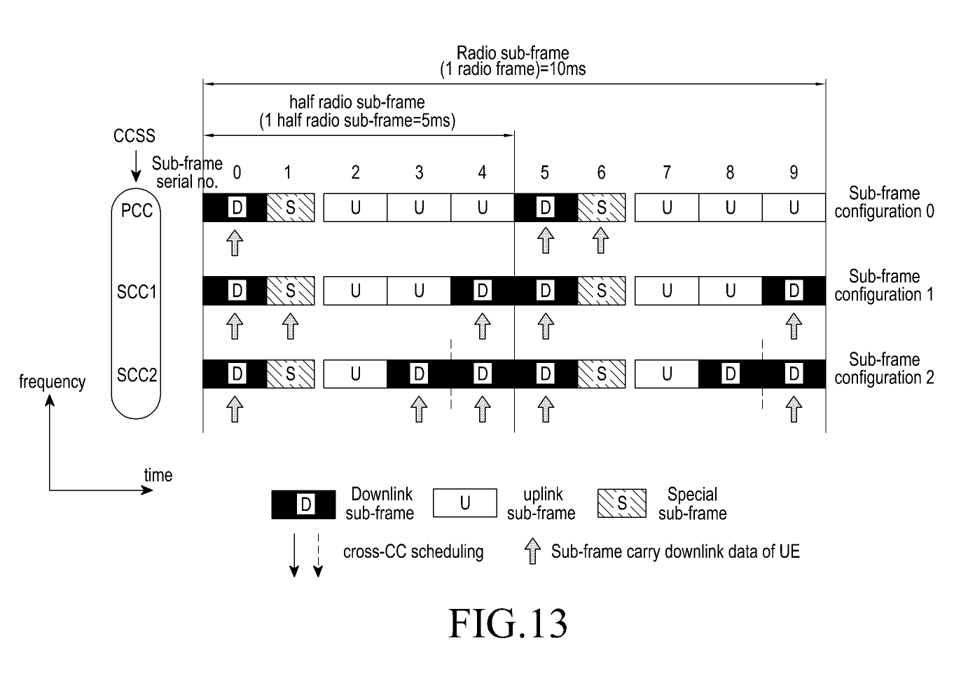

FIG. 13 is a schematic diagram of a method for scheduling a plurality of downlink sub-frames with the CIF in single downlink information according to an exemplary embodiment of the present invention.

It is assumed that there are 4 CCs in the cell, and the number of CCs configured for the UE is k, k≦4. In the present example, k=3, and the CCs assigned are marked as CCᵢ, i=0, 1, 2.

The eNB notifies the UE of its CCSS configuration information through RRC signaling. Here, the CCSS configuration information is that the CCs assigned by the UE are classified to be a CCSS, in which CC₀ is the PCC of the CCSS, and CCⱼ, 1≦j≦2 is correspondingly mapped to be SCCⱼ of the CCSS. The eNB uses configuration 0 of frame structure type 2 on CC₀, configuration 1 of frame structure type 2 on CC₁, and configuration 2 of frame structure type 2 on CC₂ (as shown in FIG. 13).

In this example, the eNB combines a multi-sub-frame scheduling field and the CIF in the DCI, to reach a desired target in that single downlink control information schedules multiple downlink sub-frames in the SCC, in which the field width of the multi-sub-frame scheduling field is l, and in this example, l=2.

The system predefines sub-frame pairs for each CCSS set. Sub-frame pair i is marked as Bᵢ(PSFᵢ,SSFᵢ⁰, SSFᵢ¹, . . . , SSFᵢ^{m-2}), i>0, m≧2, in which m is the quantity of sub-frames included in the sub-frame pair, all of the sub-frames in any sub-frame are located at a same radio frame, and all of the sub-frame control information in the sub-frame Bᵢ is sent on the PSFᵢ sub-frame of the PCC in its sub-frame pair, SSFᵢ^{j}, 0≦j<m−1 located in a certain SCC in a same CCSS, which represents the sub-frame serial number in its radio frame and 0≦SSFᵢ^{j}≦9. The serial number of the SCC is indicated by the CIF in the downlink control information, and in this example, i=0, 1, 2, 3 and m=3, j=0, 1. That is, there are 4 sub-frame pairs in a radio frame, and there are 3 sub-frames in each sub-frame pair, which are B₀(0,0,3), B₁(1,1,4), B₂(5,5,8), B₃(6,6,9).

In this example, in the radio frame observed, according to the scheduling algorithm of the eNB and the service situation of the UE, the eNB determines to send downlink packets of the UE on sub-frames 0, 5 and 6 of the PCC, to send downlink packets of the UE on sub-frames 0, 1, 4, 5 and 9 of SCC₁, and sub-frames 0, 3, 4, 5 and 9 of SCC₂. An exemplary method for scheduling downlink physical resources is described below.

Step 1: the eNb informs the UE to turn on the function of cross-CC scheduling. The values of the CIF corresponding to each CC are that CIF=“000” means that the DCI information fits for PCC, CIF=“001” means that the DCI information fits for SCC₁, and CIF=“010” means that the DCI information fits for SCC₂.

Step 2: the eNB schedules the CC position and sub-frame serial numbers according to its requirement based on existing rules of LTE version 10, and generates the DCI, in which contents of the MSS field and the CIF in each DCI are shown in Table 7.

In an exemplary implementation, the MSS field comprises 2 bits as “c₀c₁”, in which “cⱼ” means whether DCI including this MSS field fits for sub-frame SSFᵢ^{j} in the sub-frame pair, j=0, 1. More specifically, “cⱼ=1” means that DCI including this MSS field is applied for sub-frame SSFᵢ^{j} in the sub-frame pair and “cⱼ=0” means that DCI including this MSS field is not applied for sub-frame SSFᵢ^{j} in the sub-frame pair.

The downlink control information generated corresponding to each bit is marked as DCI_{SI}^{CI}, in which CI means the serial number of the CC where physical resources scheduled by DCI_{SI}^{CI} are located. In this example, CI=0 means the PCC, CI≧1 means the SCC. Also, SI means the serial number of a sub-frame in the CC indicated by CI in DCI_{SI}^{CI}. Here, SI is the serial number of a single sub-frame. In this example, according to exemplary embodiments of the present invention and scheduling algorithm of the eNB, downlink control information DCI_{SI}^{CI}, the CIF and the MSS field therein sent in different sub-frames of PCC are shown in the following Table 8.

TABLE 8

| | | | | Serial numbers of sub-frame and CC fitting for a same DCI | | | | | | | | | | |
|---|---|---|---|---|---|---|---|---|---|---|---|---|---|---|
| Serial | DCI | | | | | | | | | | | | | Serial |
| number of | information | | | Serial number of sub-frame | | | | | | | | | | number |
| subframe | carried | CIF | MSS | 0 | 1 | 2 | 3 | 4 | 5 | 6 | 7 | 8 | 9 | of CC |

| | | | | | | | | | | | |
|---|---|---|---|---|---|---|---|---|---|---|---|
| 0 | DCI₀⁰ | 000 | 00 | ✓ | | | | | | | PCC |
| | DCI₀¹ | 001 | 10 | ✓ | | | | | | | SCC₁ |
| | DCI_{0, 3}² | 010 | 11 | ✓ | | ✓ | | | | | SCC₂ |
| 1 | DCI_{1, 4}¹ | 001 | 11 | | ✓ | | ✓ | | | | SCC₁ |
| | DCI₄² | 010 | 01 | | | | ✓ | | | | SCC₂ |
| 5 | DCI₅⁰ | 000 | 00 | | | | | ✓ | | | PCC |
| | DCI₅¹ | 001 | 10 | | | | | ✓ | | | SCC₁ |
| | DCI₅² | 010 | 10 | | | | | ✓ | | | SCC₂ |
| 6 | DCI₆⁰ | 000 | 00 | | | | | | ✓ | | PCC |
| | DCI₉¹ | 001 | 01 | | | | | | | ✓ | SCC₁ |
| | DCI₉² | 010 | 01 | | | | | | | ✓ | SCC₂ |

Step 3: the UE blindly detects downlink control information in all the downlink control sub-frames in the PCC, determines the CC serial number and the sub-frame serial number of the downlink physical resources scheduled by the downlink control information according to the value of the CIF and the MSS field in the downlink control information, and receives downlink data accordingly.

It can be seen from the exemplary embodiments above, the provided method for indicating downlink physical resources in a wireless communication system uses the CIF in the downlink control information or the manner of introducing multi-sub-frame scheduling field in the existing downlink control system, to perform the scheduling of physical resources of any downlink sub-frame in the SCC, so as to achieve the peak of a real system to reach the system design target and IMT-Advanced system requirement.

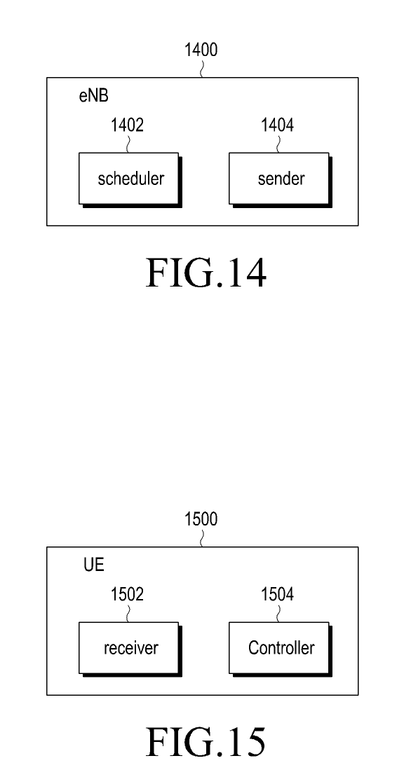

FIG. 14 is a diagram illustrating an eNB apparatus according to an exemplary embodiment of the present invention.

Referring to FIG. 14, the eNB 1400 apparatus comprises a scheduler 1402, and a sender 1404. The scheduler 1402 schedules physical resources in the at least one downlink sub-frame of one of the plurality of component carriers through a Carrier Index Field (CIF) in the downlink control information.

The sender 1404 sends, to a UE, single downlink control information to schedule physical resources in at least one downlink sub-frame of one of a plurality of component carriers at a time, through the sub-frame n of a first component carrier among the plurality of component carriers, wherein the at least one downlink sub-frame includes sub-frames n and (n+2) in each half frame, or sub-frames n and (n+3) in each half frame, and the serial numbers of each half frame are started from 0 and have an ascending order.

The scheduler 1402 expands a multi-sub-frame scheduling field in the downlink control information previously, and schedules physical resources in at least one downlink sub-frame of one of a plurality of component carriers by means of the multi-sub-frame scheduling field and the CIF in the downlink control information, wherein the value of the CIF in the downlink control information is used to determine component carriers scheduled, and the value of the multi-sub-frame scheduling field is used to determine downlink sub-frames scheduled in the component carriers scheduled.

FIG. 15 is a diagram illustrating a UE apparatus according to an exemplary embodiment of the present invention.

Referring to the FIG. 15, the UE 1500 apparatus comprises a receiver 1502, and a controller 1504.

The receiver 1502 receives, the downlink control information to schedule physical resources in at least one downlink sub-frame of one of a plurality of CCs at a time, on a first component carrier among the plurality of CCs, and receives downlink data according to the downlink control information among the plurality of CCs.

The controller 1504 determines the first CC scheduled by the downlink control information according to the value of a CIF in the downlink control information, and determines a serial number of the sub-frame in the CC scheduled by the downlink control information according to the value of multi-sub-frame scheduling field in the downlink control information.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for indicating downlink physical resources by an evolved NodeB (eNB) in a wireless communication system, the method comprising:
scheduling physical resources in at least one downlink sub-frame of one of a plurality of Component Carrier (CC)s through a Carrier Index Field (CIF) in downlink control information; and
sending, to a User Equipment (UE), single downlink control information to schedule physical resources in at least one downlink sub-frame of one of the plurality of component carriers at a time, through a sub-frame n of a first CC among the plurality of CCs,
wherein the at least one downlink sub-frame includes sub-frames n and (n+2) in each half frame, or sub-frames n and (n+3) in each half frame, and serial numbers of each half frame are started from 0 and have an ascending order.

2. The method according to claim 1, wherein the at least one downlink sub-frame is 2 sub-frame pairs predefined in each half frame, represented as Pᵢ(SF_{i,1},SF_{i,2}) wherein i=0, 1, sub-frame SF_{i,1} represents the sub-frame n, and sub-frame SF_{i,2} represents the sub-frame (n+2) or the sub-frame (n+3),
wherein if the sub-frame SF_{i,2} of the Pᵢ(SF_{i,1},SF_{i,2}) on the first component carrier is an uplink sub-frame, downlink physical resources of the Pᵢ(SF_{i,1},SF_{i,2}) on the plurality of component carriers are scheduled on the sub-frame SF_{i,1} on the first component carrier by means of the CIF by the eNB, otherwise, the sub-frame SF_{i,1} on the plurality of component carriers is scheduled on the sub-frame SF_{i,1} on the first component carrier and the sub-frame SF_{i,2} on the plurality of component carriers is scheduled on the sub-frame SF_{i,2} of a Primary Component Carrier (PCC), and
wherein the PCC refers to the only CC for sending downlink control information in any CC Scheduling Set (CCSS) assigned by the UE.

3. The method according to claim 2, wherein the first component carrier is marked as the PCC, the second to the kth component carrier being marked as Secondary Component Carriers (SCC)₁, SCC₂, . . . , SCCₖ₋₁ successively, and a value of the CIF in the downlink control information sent on the sub-frame SF_{i,1} of the PCC is represented as “b₀ b₁b₂”,
wherein, when k=2 or 3:
“b₀b₁b₂”=“000” indicates the corresponding downlink control information to schedule the downlink physical resources of the sub-frame SF_{i,1} in the PCC;
“b₀b₁b₂”=“001” indicates the corresponding downlink control information to schedule the downlink physical resources of the sub-frame SF_{i,1} in the SCC₁;
“b₀b₁b₂”=“010” indicates the corresponding downlink control information to schedule the downlink physical resources of the sub-frame SF_{i,2} in the SCC₁; and
“b₀b₁b₂”=“011” indicates the corresponding downlink control information to schedule the downlink physical resources of the sub-frames SF_{i,1} and SF_{i,2} in the SCC₁ at the same time,
wherein the SCC is used to identify other CC resources in any CCSS configured by the UE except for the PCC.

4. The method according to claim 3, wherein, when k=3:
“b₀b₁b₂”=“100” indicates the corresponding downlink control information to schedule the downlink physical resources of the sub-frame SF_{i,1} in the SCC₂;
“b₀b₁b₂”=“101” indicates the corresponding downlink control information to schedule the downlink physical resources of the sub-frame SF_{i,2} in the SCC₂; and
“b₀b₁b₂”=“110” indicates the corresponding downlink control information to schedule the downlink physical resources of the sub-frames SF_{i,1} and SF_{i,2} in the SCC₂ at the same time.

5. The method according to claim 4, wherein, when k=4 or 5:
“b₀b₁b₂”=“000” indicates the corresponding downlink control information to schedule the downlink physical resources of the sub-frame SF_{i,1} in the PCC;
“b₀b₁b₂”=“001” indicates the corresponding downlink control information to schedule the downlink physical resources of the sub-frame SF_{i,1} in the SCC₁;
“b₀b₁b₂”=“010” indicates the corresponding downlink control information to schedule the downlink physical resources of the sub-frame SF_{i,2} in the SCC₁;
“b₀b₁b₂”=“011” indicates the corresponding downlink control information to schedule the downlink physical resources of the sub-frame SF_{i,1} in the SCC₂;
“b₀b₁b₂”=“100” indicates the corresponding downlink control information to schedule the downlink physical resources of the sub-frame SF_{i,2} in the SCC₂;
“b₀b₁b₂”=“101” indicates the corresponding downlink control information to schedule the downlink physical resources of sub-frame SF_{i,1} in the SCC₃; and
“b₀b₁b₂”=“110” indicates the corresponding downlink control information to schedule the downlink physical resources of the sub-frame SF_{i,2} in the SCC₃.

6. The method according to claim 5, wherein,
when k=5, “b₀b₁b₂”=“111” indicates the corresponding downlink control information to schedule the downlink physical resources of the sub-frame SF_{i,1} in the SCC₄.

7. The method according to claim 2, wherein,
the first component carrier is marked as the PCC, the second to the kth component carrier being marked as SCC₁, SCC₂, . . . , SCCₖ₋₁ successively, and a value of the Carrier Index Field (CIF) in the downlink control information sent on the sub-frame SF_{i,1} of the PCC is represented as “b₀b₁b₂”;
when k≧2, “b₀b₁b₂”=“000” indicates the corresponding downlink control information to schedule the downlink physical resources of the sub-frame SF_{i,1} in the PCC;
“b₀b₁b₂”=“001” indicates the corresponding downlink control information to schedule the downlink physical resources of the sub-frame SF_{i,1} in the SCC₁;
“b₀b₁b₂”=“010” indicates the corresponding downlink control information to schedule the downlink physical resources of the sub-frame SF_{i,2} in the SCC₁; and
“b₀b₁b₂”=“011” indicates the corresponding downlink control information to schedule the downlink physical resources of the sub-frames SF_{i,1} and SF_{i,2} in the SCC₁ at the same time,
wherein the SCC is used to identify other CC resources in any CCSS configured by the UE except for the PCC.

8. The method according to claim 7, wherein,
when k≧3 “b₀b₁b₂”=“100” indicates the corresponding downlink control information to schedule the downlink physical resources of the sub-frame SF_{i,1} in the SCC₂; and
“b₀b₁b₂”=“101” indicates the corresponding downlink control information to schedule the downlink physical resources of the sub-frame SF_{i,2} in the SCC₂.

9. The method according to claim 8, wherein,
when k=3, “b₀b₁b₂”=“110” indicates the corresponding downlink control information to schedule the downlink physical resources of the sub-frames SF_{i,1} and SF_{i,2} in the SCC₂;
when k≧4, “b₀b₁b₂”=“110” indicates the corresponding downlink control information to schedule the downlink physical resources of the sub-frame SF_{i,1} in the SCC₃;
when k=4, “b₀b₁b₂”=“111” indicates the corresponding downlink control information to schedule the downlink physical resources of the sub-frame SF_{i,2} in the SCC₃; and
when k=5, “b₀b₁b₂”=“111” indicates the corresponding downlink control information to schedule the downlink physical resources of the sub-frame SF_{i,1} in the SCC₄.

10. The method according to claim 9, wherein,
when k=3 or k=4, “b₀b₁b₂”=“110” indicates the corresponding downlink control information to schedule the downlink physical resources of the sub-frames SF_{i,1} and SF_{i,2} in the SCC₂;
when k=4, “b₀b₁b₂”=“111” indicates the corresponding downlink control information to schedule the downlink physical resources of the sub-frame SF_{i,1} in the SCC₃; and
when k=5, “b₀b₁b₂”=“110” indicates the corresponding downlink control information to schedule the downlink physical resources of the sub-frame SF_{i,1} in the SCC₃, and “b₀b₁b₂”=“111” indicates the corresponding downlink control information to schedule the downlink physical resources of the sub-frame SF_{i,1} in the SCC₄.

11. The method according to claim 1, further comprising:
expanding a multi-sub-frame scheduling field in the downlink control information previously; and
scheduling physical resources in at least one downlink sub-frame of one of the plurality of component carriers by means of the multi-sub-frame scheduling field and the CIF in the downlink control information.

12. The method according to claim 11, wherein the value of the CIF in the downlink control information is used to determine scheduled component carriers, and the value of the multi-sub-frame scheduling field is used to determine scheduled downlink sub-frames in the scheduled component carriers.

13. The method according to claim 11, wherein the at least one downlink sub-frame is represented as Bᵢ(PSFᵢ, SSFᵢ⁰, SSFᵢ¹, . . . , SSFᵢ^{k-2}), i>0, k≧2, in which k is a quantity of sub-frames included in Bᵢ, and all of the sub-frames of a Bᵢ are located in the same radio frame,
the sending of the downlink control information to the UE on the first component carrier comprises sending the downlink control information of all of the sub-frames in Bᵢ to the UE through the sub-frame PSFᵢ in the first component carrier, and
receiving of the downlink data according to the downlink control information by the UE comprises determining the component carrier scheduled by the downlink control information according to the value of CIF in the downlink control information, and determining a serial number of the sub-frame in the CC scheduled by the downlink control information according to the value of the multi-sub-frame scheduling field in the downlink control information.

14. A method for indicating downlink physical resources in a wireless communication system, the method comprising:
receiving, by a User Equipment (UE), downlink control information to schedule physical resources in at least one downlink sub-frame of one of a plurality of component carriers at a time, on a first component carrier among the plurality of component carriers;
determining the first Component Carrier (CC) scheduled by the downlink control information according to the value of a Carrier Index Field (CIF) in the downlink control information;
determining a serial number of the sub-frame in the CC scheduled by the downlink control information according to the value of a multi-sub-frame scheduling field in the downlink control information, and
receiving downlink data according to the downlink control information among the plurality of component carriers.

15. The method according to claim 14, wherein,
a bit width of the multi-sub-frame scheduling field is k, and the multi-sub-frame scheduling field is indicated by a symbol <b₀ b₁ b₂ . . . bₖ₋₁>, in which bₘ, 0≦m<k is used to indicate whether the downlink control information including the multi-sub-frame scheduling field fits for the sub-frame SSFᵢ^{m}, 0≦m<k in Bᵢ(PSFᵢ, SSFᵢ⁰, SSFᵢ¹, . . . , SSFᵢ^{k-1}), “bₘ=1” indicates that the downlink control information including the multi-sub-frame scheduling field is used to schedule the downlink physical resources of the sub-frame SSFᵢ^{m}, 0≦m<k, and “bₘ=0” indicates that the downlink control information including the multi-sub-frame scheduling field is not used to schedule the downlink physical resources of the sub-frame SSFᵢ^{m}, 0≦m<k.

16. An evolved Node B (eNB) for indicating downlink physical resources in a wireless communication system, the eNB comprising:
a scheduler for scheduling physical resources in at least one downlink sub-frame of one of a plurality of component carriers through a Carrier Index Field (CIF) in downlink control information; and
a sender for sending, to a User Equipment (UE), single downlink control information to schedule physical resources in at least one downlink sub-frame of one of the plurality of component carriers at a time, through a sub-frame n of a first component carrier among the plurality of component carriers,
wherein the at least one downlink sub-frame includes sub-frames n and (n+2) in each half frame, or sub-frames n and (n+3) in each half frame, and serial numbers of each half frame are started from 0 and have an ascending order.

17. The eNB according to claim 16, wherein the scheduler expands a multi-sub-frame scheduling field in the downlink control information, and schedules physical resources in at least one downlink sub-frame of one of the plurality of component carriers by means of the multi-sub-frame scheduling field and the CIF in the downlink control information.

18. The eNB according to claim 17, wherein the value of the CIF in the downlink control information is used to determine scheduled component carriers, and the value of the multi-sub-frame scheduling field is used to determine scheduled downlink sub-frames in the scheduled component carriers.

19. A User Equipment (UE) for indicating downlink physical resources in a wireless communication system, the UE comprising:
a receiver for receiving downlink control information, to schedule physical resources in at least one downlink sub-frame of one of a plurality of Component Carriers (CCs) at a time, on a first component carrier among the plurality of CCs, and for receiving downlink data according to the downlink control information among the plurality of CCs; and
a controller for determining the first CC scheduled by the downlink control information according to the value of a Carrier Index Field (CIF) in the downlink control information, and for determining a serial number of the sub-frame in the CC scheduled by the downlink control information according to the value of multi-sub-frame scheduling field in the downlink control information.
